(19) United States
(12) Patent Application Publication
(10) Pub. No.: US 2004/0197168 A1
(43) Pub. Date: Oct. 7, 2004

(54) Device for the transport of metallic work pieces

(76) Inventors: Heinz Meurs, S'Heerenberg (NL); Torsten Hesse, Kleve (DE)

Correspondence Address: CANTOR COLBURN, LLP, 55 GRIFFIN ROAD SOUTH, BLOOMFIELD, CT, 06002

(21) Appl. No.: 10/801,857

(22) Filed: Mar. 17, 2004

(30) Foreign Application Priority Data
Apr. 4, 2003 (DE) 203 05 423.7

(51) Int. Cl. B65G 25/00

(52) U.S. Cl. 414/150

(57) ABSTRACT

Device for the transport of metallic work pieces during a heat treatment including a transport device, a carriage movable transverse to a transport direction, a rack for carrying the transport device that is movable relative to the carriage, where the transport device is float-mounted in relation to the carriage.

The invention concerns a device for the transport of metallic work pieces, in particular during a heat treatment with a transport device and a carriage moving the transport device horizontally.

Devices of the above named type are known from the state of the art, for example from EP 1 229 137 and have proven themselves in everyday practice. They serve the purpose to transport work pieces to be fed to different heat treatment chambers within the framework of a heat treatment in a simple fashion and to feed them to the appropriate heat treatment chambers as needed. Here it is especially advantageous that the transport device operates independently from the respectively modular like constructed heat treatment chambers, making it possible for the user to approach individual treatment chambers in a modifiable sequence as needed. In order to make sure that the work pieces to be treated are only exposed to a specifiable atmosphere during the transport, it can be provided according to EP 1 229 137 that the transport device is designed as a heat insulating and vacuum tight transport chamber.

It is essential in such a design of the transport device that the transport device and the approaching heat treatment chamber can be coupled with each other in a vacuum tight and heat insulated fashion. For this purpose, it is necessary to position the transport device on the one hand and the heat treatment chamber on the other hand exactly in their appropriate position so that a defined coupling of the transport device to the appropriate heat treatment chamber can be implemented. Even minor deviations in the positioning of the transport device and/or the heat treatment chamber could lead to a positioning imprecision whereby a safe, meaning in particular a vacuum tight coupling of transport device and heat treatment chamber cannot always be guaranteed. Reasons for such a positioning imprecision could be manufacturing tolerances, wear-conditioned abrasions, temperature influences operating in different manners or pressure differences.

Based on such positional deviations, problems arose in the past in the coupling of the transport device, disadvantageously resulting in prolonged operational times or even in operational interruptions.

It is, therefore, the object of the invention to provide a device for the transport of metallic work pieces that facilitates a exact positional coupling of the transport device to the matching module, for example a heat treatment chamber.

The problem is solved with a device for the transport of metallic work pieces characterized in that the transport device is carried by a rack that is movable relative to the carriage, whereby the transport device is mounted floating relative to the rack.

The transport device is arranged horizontally movable via, for example, a carriage movable on rails. The transport device can be moved up to individual matching modules with this method, for example heat treatment chamber. The transport device is carried by a rack that is movable relative to the carriage facilitating a coupling of the transport device relative to the carriage after the transport device approaches the matching module. The positioning of the transport device, therefore takes place based on two different movements. With a first traversing motion the transport device is moved to the appropriate matching module via a horizontally movable carriage as needed and in a second traversing motion the transport device is moved for the coupling process to the matching module relative to the carriage. During the second traversing motion, the coupling of the transport device to the matching module takes place, whereby it is provided according to the invention that the transport device is mounted floating relative to the rack. Potential positional imprecisions of the transport device versus the matching module can thus be balanced, so that a desired coupling of the transport device on the one hand and the matching module on the other hand can be achieved in any case. The float-mounting of the transport device makes it possible to balance a potential tilting of the transport device versus the approaching matching module that can result, for example, due to manufacturing tolerances. A heat-insulating and vacuum tight connection between the transport device and the matching module can be advantageously guaranteed.

A floating or a flexible positioning in the sense of the invention is a positioning that can compensate for position imprecisions, meaning tilting in reference to the horizontal level.

The float-mounting of the transport device is preferably formed by a number of elastic bearing elements located between the transport device on the one hand and the rack on the other hand. Preferably there a force-transmitting connection between the transport device and the rack is formed through interposing a bearing element. For example, connecting the transport device and the rack with each other at four bearing positions in a power force-transmitting fashion can be provided. Correspondingly a total of four bearing elements would be provided, whereby one bearing element would be located per bearing position between the rack and the transport device.

According to an additional characteristic of the invention, the bearing elements are preferably equipped with a molded element made of rubber. Thus, an elastic positioning of the transport device versus the rack is achieved, whereby the float-mounting described previously is guaranteed. The molded element preferably is equipped with a locking plate made of metal, preferably of steel on the rack side and the transport device side in each case. This facilitates a good connectivity of the bearing element with the transport device as well as with the rack on the one hand as well as a good introduction of the bearing forces to be accommodated by the bearing elements. Additionally, the connection boards can accept a comparably high vertical force with a minor deformation guaranteeing a safe positioning even when the transport device is loaded with work pieces.

According to an additional characteristic of the invention, the molded element is equipped with a liner plate consisting at least of metal but preferably of steel. The previously described effect that the bearing elements can accept a high vertical force with a simultaneous minor deformation is strengthened advantageously by this measure.

In total a float-mounting of the transport device is achieved with the bearing elements of the invention in a simple and economic fashion that can compensate for larger movements and positioning imprecisions relative to the horizontal level of the transport device, whereby it is simultaneously guaranteed that higher vertical forces can be accommodated by the bearings.

In order to prevent damage of the bearing elements due to shearing forces, it is provided according to another characteristic of the invention that the connection board or the liner plate is vulcanized on or in the molded element. A safe introduction of force or transmission of force within the bearing element is guaranteed with this method.

According to an additional characteristic of the invention, it is provided that the transport chamber has a clamping device arranged on the adapter side for a vacuum-tight connection of a transport device constructed as a transport chamber to a correspondingly constructed matching module. The whole purpose of this clamping device is the definite fixation of the transport chamber versus the matching module. A transport device using the flexible bearing for a accurately positioned approach of a transport device towards the matching module can be mounted stably on the matching module with the help of a clamping device in such a way that no relative mobility between the transport device and the matching module is possible after the coupling of the transport device. The formation of a gas- and/or vacuum tight connection between the transport device and the matching module can be stabilized in its position until the clamping device is loosened.

As an alternative to the above described clamping device, it is, of course, also possible to effect a vacuum tight connection between the transport device and the matching module through contact pressure of the transport device to the matching module, but in practice the use of a clamping device has proven itself as especially effective. A centralizing device can be provided on the matching module for the support of the coupling process that centralizes the approaching transport device relative to the openings at the transport device and those of the matching module.

According to an additional characteristic of the invention, the clamping device consists of at least two movable clamps that engage in a bracing position with the abutment located at the matching module. The two movable clams are preferably positioned opposite to each other at the transport device and are extended after the positioning of the transport device relative to the matching module and are hooked into the abutment located at the matching module. Then the clamps are tightened generating the definite contact pressure for the transport device and the matching module. The clamping devices are preferably constructed rotatable for a simplified engagement of the clamps in the abutments located on the matching module.

The clamping devices are preferably formed by a hydraulic, pneumatically and/or electrically movable or rotatable cylinder on the matching module end of which clamping irons are constructed. The clamping irons are preferably fastened interchangeably on the cylinder so that they can be selected and mounted as needed according to size and weight.

The transport device is equipped with a seal on the connection side, preferably in form of an O-ring for the formation of a gas- and/or vacuum tight connection between the transport device and the matching module. After contact pressing of the transport device to the matching module, a sealing is achieved between the transport device and the matching module fulfilling all requirements so that work pieces can be transferred from the matching module to the transport device and vice versa excluding the surrounding atmosphere of the equipment.

Additional advantages and characteristics result from the following descriptions of the drawings, wherein:

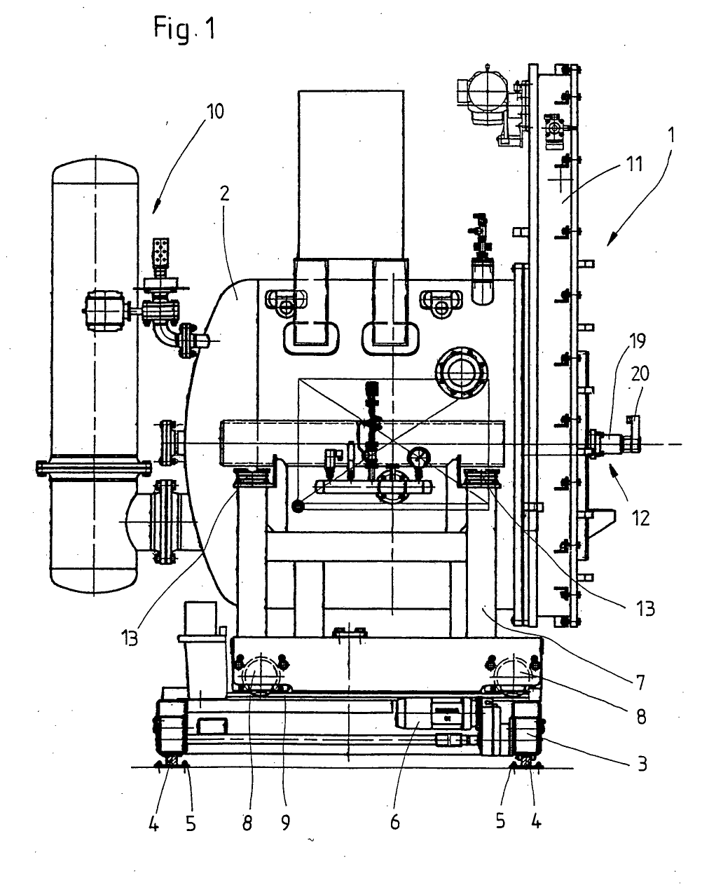

FIG. 1: Illustrates a schematic side view of a device for the transport of metallic work pieces according to the invention;

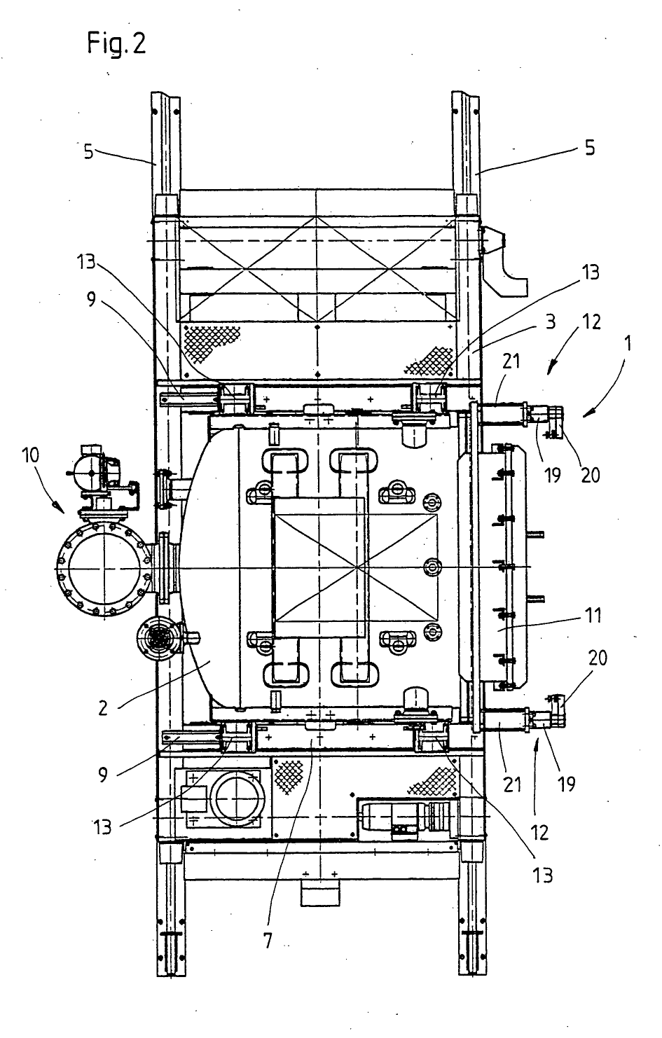

FIG. 2: Illustrates a schematic top view of a design for the transport of metallic work pieces according to the invention;

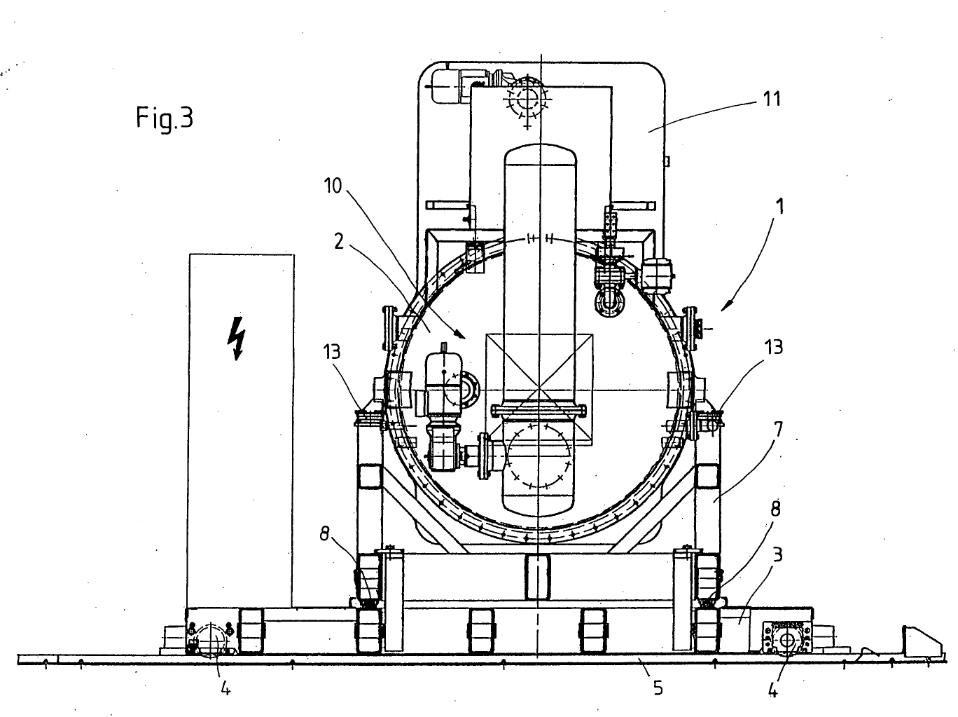

FIG. 3: Illustrates a schematic rear view of a device for the transport of metallic work pieces according to the invention;

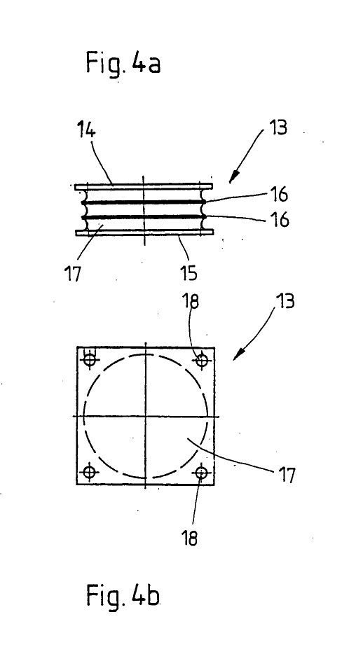

FIG. 4a: Illustrates a side view of a bearing element;

FIG. 4b: Illustrates a top view of a bearing element;

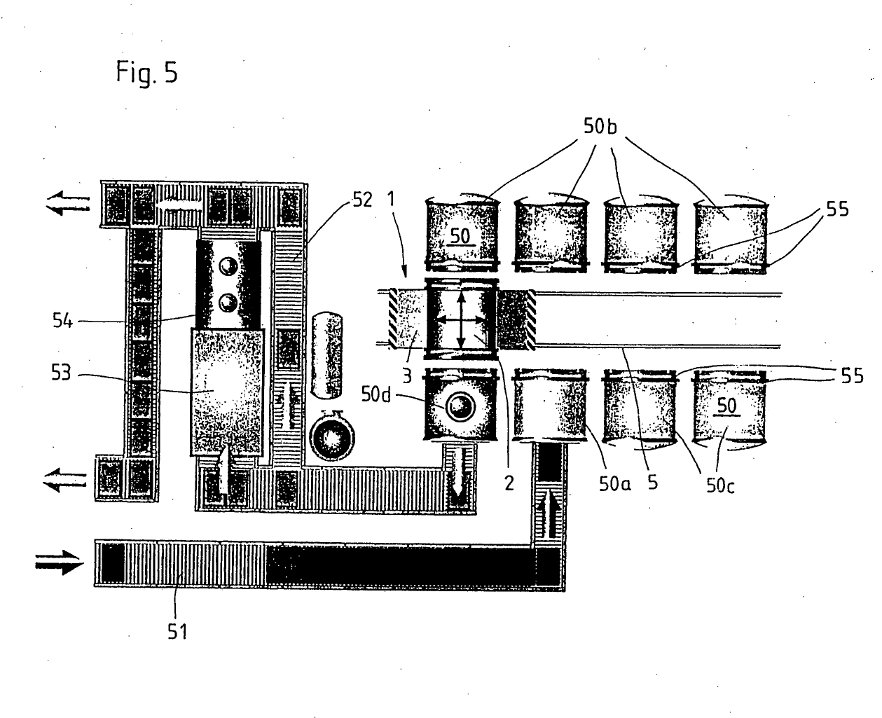

FIG. 5: Illustrates a schematic depiction of a facility for the heat treatment of metallic work pieces using a device according to FIGS. 1 to 3 and

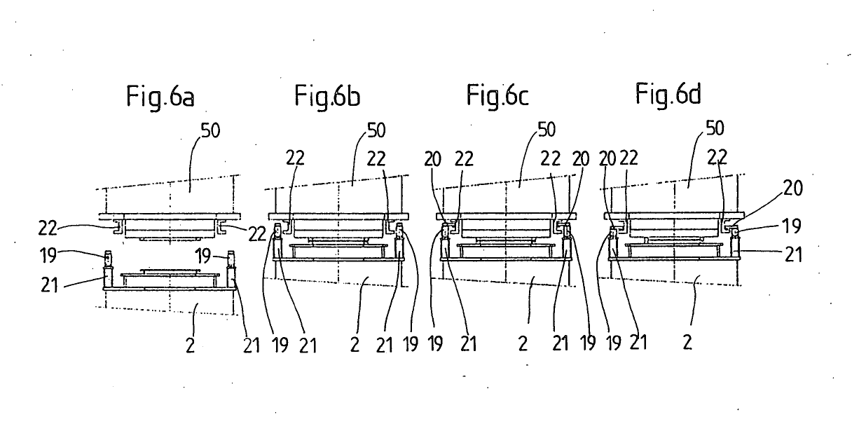

FIG. 6a to 6d: Illustrate a schematic top view concerning the individual steps of the coupling process.

A device for the transport of metallic work pieces is represented in FIGS. 1 to 3, whereby the shown device 1 is equipped with a transport device in the form of an outwardly designed heat-insulating and vacuum tight cylindrical transport chamber 2. The transport chamber 2 serves for the accommodation and the transport of work pieces (not shown in detail) combined in a charge.

The device 1 furthermore comprises a carriage 3 where the transport chamber 2 is horizontally movable. The carriage 3 consists preferably of a frame construction that is not shown in detail that is guided with corresponding wheels 4 in rails 5 constructed for them. An electric motor 6 located on the carriage 3 provides the drive. The transport device in the form of a transport chamber 2 is carried by a rack 7 that is mounted transversely to the movement direction of the carriage 3 movable upon it. For this purpose, the rack 7 can be moved via wheels 8 with which the rack 7 on the carriage 3 can be moved on the rails 9 relative to the carriage 3.

The device 1 is also equipped with the devices for loading and unloading of the work pieces arranged in the transport chamber 2, which are not represented in detail, which have a horizontally movable latch. The latch can be moved horizontally via a pressure chain that can be moved back and forth through an electromechanical drive, whereby the guidance of the return strand takes place in a vertical acceptance. With this method it is guaranteed that all starting and braking processes in reference to a reliable transport of the work piece from the transport chamber 2 to the treatment chamber 50 run smoothly or vice versa, jerk-free, as is shown in FIGS. 5 and 6a to 6d.

The transport chamber 2 is connected to a vacuum facility 10, as can be gathered especially in FIGS. 1 to 3. This facility makes it possible to evacuate the interior of the transport chamber 2 to a final pressure of approximately 0.1 mbar and to keep it at this pressure level with a leakage rate of approximately 0.003 mbar 1/sec. Thus, it is guaranteed that the heat-treated work pieces located in the transport chamber 2 are protected from environmental influences, such as an oxygen supply leading to an undesired oxidation.

In order to avoid a significant temperature drop of the work pieces heated first in a treatment chamber 50, the transport chamber 3 is equipped with an exchangeable thermal insulation, made, for example from chromium-nickel-steel and has in addition heating elements connected to a current duct. The heating elements permit a heating of the empty transport chamber 2 to approximately 1200° C. within the shortest time with a control temperature of approximately ±5° C.

A hermetically closing loading door is located at the front side of the transport chamber 2 that can be raised vertically through in this case a hydraulic drive, which also could be actuated by an electrical or pneumatic drive depending on the application. For opening or closing, the loading door is moved in a double-walled portal 11 where a clamping device in form of a clamp 11 is located at the side turning away from the transport chamber 2. The carriage 3 of the device 1 equipped with wheels 4 is actuated by an electric motor 6 starting and braking jerk-free via a converter 6, preferably a geared motor. The traveling speed that permits a positioning accuracy of approximately 1 mm of the carriage 3 that is freely running in all directions and rotating on the spot ranges only from 0.01 m/sec and 0.03 m/sec, making additional safety measures such as a grid arrangement dispensable. Safety devices are provided at the front and rear end of the carriage 3 in order to trigger an emergency stop upon striking an obstacle.

The rails arranged on the carriage 3 serve for the relative mobility of the transport chamber 2 in reference to the carriage 2, whereby a mobility of approximately 200 mm of the transport chamber 2 is possible. Here the transport chamber is moved by a hydraulic cylinder that is not shown.

The transport chamber 2 is float-mounted in the rack 7 via flexible bearing elements 13 for the accurately positioned coupling of the transport chamber 2 to the treatment chamber 2 serving as an matching module. Due to this floating position, the transport chamber 2 is arranged in a movable fashion at a level running horizontally relative to the rack 9 so that the position- and bearing imprecision between the transport chamber 2 on the one hand and the treatment chamber 50 on the other hand can be equalized. A safe docking, meaning a safe vacuum tight coupling of the transport chamber 2 to the matching module, can thus be guaranteed advantageously. A centralizing device for the support of the coupling process can be provided that can be mounted either on the matching module or on the transport chamber 2.

Bearing elements 13 preferably to be used are shown as examples in FIGS. 4a and 4b. The bearing element consists of an elastic material, for example of a molded element 17 made of rubber. The molded element 17 is equipped with a connection plate 14 or 15 on the carrier side, as well as on the transport chamber side, that is made of metal preferably of steel. These connection plates 14 or 15 are provided with boreholes 18 that facilitate a force-transmitting connection between the transport chamber 2 on the one side and the rack 7 on the other side in a simple fashion. The liner plates 16 are embedded in the molded element 17. The connection plates 14 and 15, as well as the liner plates 16 together contribute to the fact that the bearing elements 13 have a high vertical force with only a minor deformation. On the horizontal level, meaning on a level that is essentially parallel to the connection boards or liner plates, all movements, meaning position and bearing imbalances of the transport chamber 2, can be balanced and compensated for relative to the rack 7. Thus, an accurately positioned alignment of the transport chamber 2 relative to the matching module is possible. The floating or flexible positioning of the transport chamber 2 thus facilitates a coupling of the transport chamber 2 with the matching module 50 compensating for the position imbalances.

The clamping devices 12 located at the transport chamber 2 serve for the definite arrangement of the transport chamber 2 at the treatment chamber 50. They have a movable design and can be moved as needed in such a way that the transport chamber 2 is contact pressured to the treatment chamber 50 by forming a vacuum tight connection.

The clamping device 12 is formed by a hydraulic cylinder 19 and a clamping iron 20 located at the end side of the hydraulic cylinder 19. Each hydraulic cylinder 19 is carried by a cross bar 21 that, in turn, is located at each transport chamber 2. The hydraulic cylinders 19 can be moved perpendicular to the direction of movement of the carriage 3 and can be rotated around the longitudinal axis of the hydraulic cylinders 19. In a bracing position, the irons 20 of the clamping devices 12 engage in the abutments 22 that are formed at the treatment chamber 50, as can be seen in FIGS. 6a-6d, in particular.

The coupling process of the transport chamber 2 to the treatment chamber 50 is represented in FIGS. 6a-6d. Positioned by the carriage 3, the transport chamber 2 is located opposite the treatment chamber 50 in FIGS. 6a-6d, where the transport chamber 2 should be coupled. According to the position shown in 6a, the transport chamber 2 is still at a relative distance from the treatment chamber 50, while the clamping devices 12 remain in their original position.

According to the position shown in FIG. 6b, the transport chamber 2 and the rack 7 are offset relative to the carriage 3 and approach them in the direction of the treatment chamber 50. In this position, the transport chamber 2 and the treatment chamber 50 only distanced a few millimeters from each other. Even with the transport chamber 2 in this position, the clamping devices 12 still remain in their original position. As soon as the transport chamber 2 reaches the position shown in FIG. 6b, the hydraulic cylinders 9 of the clamping device 12 twist by 90° so that the clamps 20 of the clamping device 12 engage with the abutments 22 formed at the matching module. During the next process step shown in FIG. 6d, the hydraulic cylinders 12 move back in the direction of the transport chamber 2 whereby, due to the shoring up of the clamps 20 from the abutments 22, the transport chamber 2 is pulled the remaining few millimeters to the treatment chamber 50 and is contact pressured, vacuum tight to it. The transport chamber can be equipped on the adaptor side with a seal, preferably in the form on an O-ring.

According to the invention, a positioning or bearing-balancing option of the transport chamber 2 is created relative to the treatment chamber 50 by using float-mounting, making it possible to balance a potential tilting of the transport chamber 2. A balanced positioning of the transport chamber 2 relative to the treatment chamber 50 achieved with this method can be stabilized with the use of the clamping device 12 whereby a vacuum tight connection is achieved between the transport chamber 2, on the one hand and the treatment chamber 50 on the other hand, by contact-pressuring the transport chamber 2 with the interposition of the appropriate seal through the clamping device 12 close to the treatment chamber 50. As soon as the loading or unloading process has been completed, the clamping devices 12 can be loosened again, whereby the treatment chamber 2 is again released and can be moved again relative to the treatment chamber 50.

FIG. 5 shows an example of a facility where the described device 1 is used according to the FIGS. 1 to 3. On both sides of the device 1, a number of different treatment chambers 50 are assembled on both sides of the device 1, whereby a vacuum preheating chamber 58, negative pressure carburization chamber 50b, diffusion chamber 50c, and the gas tempering chamber 50d, or alternatively, an oil or saline bath tempering chamber are provided.

In order to transport the untreated work pieces that have been introduced at the beginning via a conveyor belt or a roller conveyor 51 into the vacuum preheating chamber 50a to the treatment chamber 50 appropriate for each heat treatment, the transport chamber 2 of the transport device 1 is coupled to the vacuum preheating chamber 50a via the sluice arranged stationary before each treatment chamber 50. In the above-described fashion, the coupling takes place using the previously described clamping devices 12.

The lock 55 and the transport chamber 2 are evacuated for the loading of the transport chamber 2 with the work pieces. Then the doors of the vacuum preheating chamber 50a and lock 55, as well as the loading door of the transport chamber 2 are opened and the work pieces are transported via a lift fork into the transport chamber 2. After the loading door is closed again; the transport chamber 2 is transported to the negative pressure carburization chamber 50b. The thermal insulation, as well as the heating elements, guarantee that the work pieces do not experience any loss of temperature. After reaching the position of the corresponding carburization chamber 50b, a second door opposite the loading door opens to the transport device 1 that is movable on the rails 5 in a straight line and the work pieces are moved via the lock at the treatment chamber 50 with a lift fork into the carburization chamber 50d

During a further transport of the work pieces, for example, into a diffusion chamber 50c; or a gas tempering chamber 50d, the described process repeats itself in a corresponding manner. The locks 55 that can be evacuated separately contribute to the fact that the work pieces are transported without any great loss of time, even between the treatment chambers 50 that house different atmospheres, for example, in the carburization chamber 50b and the diffusion chamber 50c, whereby it is simultaneously guaranteed that the work pieces are transported in a vacuum that protects it from the environmental influences in the interior of the transport chamber 2. Finally, the work pieces leave the gas tempering chamber 50d via a conveyor belt 52 that moves the work pieces according to the type of heat treatment to a tempering furnace 53 and then to a cooling tunnel 54.

Reference Numbers

1 device

2 transport chamber

3 carriage

4 wheel

5 rail

6 electric motor

7 rack

8 wheel

9 rail

10 vacuum facility

11 portal

12 clamping device

13 bearing element

14 connection board

16 liner plate

17 molded element

18 borehole

19 hydraulic cylinder

20 clamping iron

21 cross bar

22 abutment

50 treatment chamber/matching module

50a vacuum preheating chamber

50b negative pressure carburization chamber

50c diffusion chamber

50d gas tempering chamber

51 conveyor belt/roller train

52 conveyor belt/roller train

53 tempering furnace

54 cooling tunnel

55 sluice

1. Device for the transport of metallic work pieces during a heat treatment comprising: a transport device carriage movable transverse to a transport direction a rack for carrying the transport device that is movable relative to the carriage; where in the transport device is float-mounted in relation to the carriage.

2. Device according to claim 1, wherein the float-mounting of the transport device is formed by a number of elastic bearing elements located between the transport device and the rack.

3. Device according to claim 2, wherein the bearing elements comprise a molded element made of rubber.

4. Device according to one of the previous claims 3, wherein the molded element is respectively equipped with a locking plate made of metal, on a rack side and on a transport device side.

5. Device according to claims 3, wherein the molded element is further comprises at least one liner plate made of metal.

6. Device according to claims 5, wherein the liner plate is vulcanized on or in the molded element.

7. Device according to claims 1 wherein the transport device is a heat-insulated and gas and/or vacuum tight transport chamber.

8. Device according to claim 1, further comprising: a clamping device for forming a vacuum-tight seal when connected with a corresponding clamping device on a matching module.

9. Device according to claim 8, wherein the clamping device is formed from at least two clamping devices that are movable relative to the transport chamber that engage in a bracing position in abutments formed at the matching module.

10. Device according to claim 9, wherein the clamping devices can be rotated.

11. Device according to claim 9, wherein the clamping devices can be moved or twisted hydraulically, pneumatically and/or electrically.

12. Device according to claim 9, wherein the clamping devices are equipped with clamps at the matching module end.

13. Device according to claim 8, wherein the abutments formed at the matching module correspond in form to the clamps.

14. Device according to claims 1, wherein the transport chambers on an adapter side are equipped with a seal.

15. Device according to claim 4, wherein the locking plate is vulcanized on or in the molded element.

16. Device according to claim 14, wherein the seal comprises an o-ring.
